(19) United States
(12) Patent Application Publication
(10) Pub. No.: US 2026/0242547 A1
(43) Pub. Date: Aug. 20, 2026

(54) POLYMERIZABLE MONOMER

(71) Applicant: UNIVERSITÄT LINZ, Linz (AT)

(72) Inventors: Stephan HAUDUM, Linz (AT); Ian TEASDALE, Linz (AT); Oliver BRÜGGEMANN, Wilhering (AT); Nico VENNEMANN, Linz (AT)

(73) Assignee: UNIVERSITÄT LINZ, Linz (AT)

(21) Appl. No.: 19/159,308

(22) PCT Filed: Feb. 26, 2024
(86) PCT No.: PCT/AT2024/060068

§ 371 Date: Aug. 24, 2025

(30) Foreign Application Priority Data
Mar. 1, 2023 (AT) A50147/2023

(51) Int. Cl. C08G 79/025

(52) U.S. Cl. CPC C08G 79/025

(57) ABSTRACT

A polymerizable monomer which has exactly one phosphorus atom, wherein an oxygen atom having a double bond is present on the phosphorus atom, and wherein two or three identical amino acids are each bound to the phosphorus atom via one NH group, wherein, in the case of two identical amino acids, one R1 residue is bound to the remaining binding site of the phosphorus atom, wherein each amino acid has an amino acid residue adjacent to the NH group, and wherein the hydroxy group of the carboxy group of the amino acid is replaced by X—R3, wherein R3 is another residue, and wherein X is selected from O, NH, S, and CH₂, and wherein at least the Amino acid residue R2 or the R3 residue includes a polymerizable group.

### CROSS-REFERENCE TO RELATED APPLICATIONS

The present application is a national phase application of PCT Application No. PCT/AT2024/060068, filed Feb. 26, 2024, entitled “POLMERIZABLE MONOMER”, which claims the benefit of Austrian Patent Application No. A50147/2023, filed Mar. 1, 2023, each of which is incorporated by reference in its entirety.

### BACKGROUND OF THE INVENTION

### 1. Field of the Invention

The invention relates to amino acid phosphoramidate monomers for forming degradable polymers.

### 2. Description of the Related Art

It should be emphasized in distinction from prior art that the present amino acid phosphoramidate monomer is a monomer, as its name suggests, and not a polyphosphazene. Polyphosphazenes are defined as a substance class of hybrid, inorganic-organic polymers whose backbone is formed by alternating phosphorus and nitrogen atoms with alternating single and double bonds. Thus, a polyphosphazene has an inorganic backbone, with degradation taking place via backbone decomposition.

US20090004741A1 relates to biodegradable polymer compositions that contain both phosphoester bonds in their polymer backbone and attached groups bound to the backbone via PN binding. The polymers are useful in drug and gene delivery, in particular as carriers for gene therapy and the delivery of protein drugs. The backbone of such polymers is formed by phosphoesters.

The present invention includes no polyphosphazenes, only phosphoramidate monomers, wherein two or three amino acids are bound to the phosphorus atom, the amino acids each having one polymerizable group. Cross-linking such monomers is done not via the phosphorus atom when forming polyphosphazene, but by cross-linking via the polymerizable groups of the amino acids. Hence, the polymer obtained by cross-linking the present monomers does not have a backbone made of alternating phosphorus and nitrogen atoms with alternating single and double bonds, neither does it have a backbone made of phosphoester.

In the present monomer, the amino acids are bound to the phosphorus atom via an NH group.

Degradation of a polymer made of cross-linked inventive monomers takes place by releasing said NH bond by means of water. Degradation by decomposition of a polyphosphazene backbone, however, is not possible, since no such backbone is present.

### SUMMARY OF THE INVENTION

It may be found that the object of the invention is to provide a monomer that can be cross-linked into a polymer, which is degradable under mild conditions with controllable or definable degradation properties.

To achieve said object, a monomer of claim 1 is proposed.

In one variant embodiment, a monomer is proposed, which has exactly one phosphorus atom, wherein two or three identical amino acids are each bound to the phosphorus atom via an NH group, wherein each amino acid has an amino acid residue R2 adjacent to the NH group, and wherein the hydroxy group (—OH) of the carboxy group (—COOH) is replaced by X—R3, wherein X is selected from O, NH, S, and CH₂, and at least the amino acid residue R2 or the residue R3 comprises a polymerizable group.

Preferably, the amino acids are natural amino acids, so that the amino acid residue R2 is dictated by the choice of natural amino acid. However, the amino acid residue R2 may also be the residue of a synthesized unnatural amino acid. However, the amino acid residue R2 may also be the residue of an amino acid derivative.

Since the amino acid residue R2 is adjacent to the NH bond of the amino acid to the phosphorus atom, it substantially affects the releasability of the NH bond by water.

If R2 is a large group, water molecules are more likely prevented from reaching the NH bond than of R2 is a small group.

If R2 is a hydrophobic group, water molecules are more likely prevented from reaching the NH bond than of R2 is a hydrophilic group.

Thus, the degradation rate of the monomer and that of a polymer based on the monomers may be influenced by the choice of amino acid residue R2.

Since above connection between the characteristics of R2 and the degradation rate has been researched as part of the present invention, a certain degradation behavior to be expected upon choosing a suitable amino acid residue R2 may be estimated.

As mentioned above, two or three identical amino acids may be present on the phosphorus atom.

A first variant embodiment thus consists in two identical amino acids being present. The monomer is thus an amino acid phosphorodiamidate (APdA).

A second variant embodiment thus consists in three identical amino acids being present. The monomer is thus an amino-acid phosphorotriamidate (APdA), but it is also possible to refer to it as an amino-acid phosphoramide.

Both variants include an oxygen atom having a double bond present on the phosphorus atom.

Hence, in the second variant embodiment, all binding sites of the phosphorus atom are occupied by the three identical amino acids and the oxygen double bond.

In the first variant embodiment, another residue R1 is bound to the remaining free binding site of the phosphorus atom. The residue R1 may be present on the phosphorus atom via an O bond, an NH bond, or an S bond. The residue R1 may be chosen freely. R1 may or may not be polymerizable. R1 may or may not affect the degradation rate.

R1 is in particular determined by the choice of phosphate which is used to synthesise the present monomer. Preferably, it is a dichlorophosphate which has, in addition to the oxygen double bond, two chlorine single bonds and the residue R1 at the remaining binding site. For example, ethyl dichlorophosphate may be used. In the synthesis, the amino acids replace the chlorine atoms and the residue R1 remains on the phosphorus atom.

In one variant embodiment, the inventive monomer has a structure according to the structural formula,

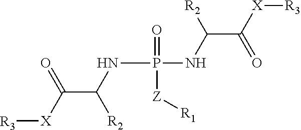

wherein X preferably represents O, NH, or S and Z represents O, NH, or S, wherein R2 or R3 is a polymerizable group, and wherein any residue can be chosen for R1.

In one variant embodiment, the inventive monomer has a structure according to the structural formula,

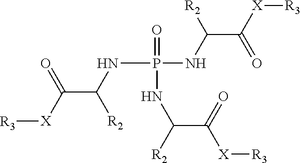

wherein X preferably represents O, NH, or CH₂, wherein R2 or R3 is a polymerizable group.

R2 is preferably the side chain of alanine, arginine, asparagine, aspartic acid, cysteine, glutamine, glutamic acid, glycine, histidine, isoleucine, leucine, lysine, methionine, phenylalanine, proline, serine, threonine, tryptophane, tyrosine, valine.

Preferably, the residue R3 is bound to the hydroxy group of the amino acid via an ester bond (X representing O).

When using an amino acid derivative, an amide bond (X representing NH) or a thioester bond (X representing S) may be present instead of the ester bond.

The residue R2 or the residue R3 is polymerizable and serves to cross-link identical inventive monomers into a polymer. The cross-linking may be by polymerization.

In one variant embodiment, only the residue R2 is polymerizable.

In one variant embodiment, only the residue R3 is polymerizable.

In one variant embodiment, the residue R2 and the residue R3 are polymerizable.

Cross-linking of polymerizable residues of multiple monomers may be directly to one another. This means that the polymerizable residue of a first monomer is bound to the identical polymerizable residue of an identical second monomer. The polymer may be a copolymer in which the present monomers are polymerized in the presence of at least one second type of monomers.

For polymerization, a thiol compound having at least two thiol groups may be employed as the second type of monomers.

Preferably, the thiol compound as three thiol groups.

A suitable thiol compound may be, for example, trimethylolpropane tris(3-mercaptopropionate).

Polymerization via a thiol-ene addition allows covalent binding of various molecules to a thiol group.

A preferred use of the polymerizable monomers includes them, in a non-polymerized state, being present as a liquid in a device for 3D printing, in particular a device for photopolymerization 3D printing or multi-photon lithography and being cured into a 3D structure or a 3D object.

The technology of photopolymerization 3D printing is known in prior art and includes various processes based on the same fundamental strategy: A liquid photopolymer in a container (or tank) is selectively cured by a light source. A physical 3D object is created layer for layer, until it is complete. In addition to the oldest technology based on lasers, there are multiple types of curing equipment. Projectors with digital light processing and even LCD screens are a popular method of photopolymerizing materials due to their low cost and super-high resolution.

The present polymerizable monomers are suitable for this application.

### BRIEF DESCRIPTION OF THE DRAWINGS

The invention is illustrated based on a preparation example and a drawing:

FIG. 1: Shows the reaction scheme for preparing an exemplary inventive monomer having two identical amino acids.

FIG. 2: Shows the reaction scheme for degrading an exemplary inventive monomer having two identical amino acids.

FIG. 3: Shows the reaction scheme for preparing an exemplary inventive monomer having three identical amino acids.

FIG. 4: Shows the reaction scheme for degrading an exemplary inventive monomer having three identical amino acids.

FIG. 5: Shows the structural formula of the monomer of example 1 designated APdA-1.

FIG. 6: Shows the structural formula of the monomer of example 2 designated APdA-2.

FIG. 7: Shows the structural formula of the monomer of example 3 designated APdA-3.

FIG. 8: Shows the structural formula of the monomer of example 4 designated APdA-4.

FIG. 9: Shows the structural formula of the monomer of example 5 designated APdA-5.

FIG. 10: Shows the structural formula of the monomer of example 6 designated APdA-6.

FIG. 11: Shows the structural formula of the monomer of example 7 designated APdA-7.

FIG. 12: Shows the structural formula of the monomer of example 8 designated APdA-8.

FIG. 13: Shows the structural formula of the monomer of example 9 designated APtA-1.

FIG. 14: Shows the structural formula of the monomer of example 10 designated APtA-2.

FIG. 15: Shows the structural formula of the comparative monomer designated PDA.

FIG. 16: Illustrates the degrading behavior of APdA-1, APdA-2, and PDA at pH 7.4.

FIG. 17: Illustrates the degrading behavior of APdA-2 at pH 3.

FIG. 18: Illustrates the degrading behavior of APdA-1, APdA-2, and PDA at pH 3.

FIG. 19: Illustrates the degrading behavior of polymers based on APdA-1, APdA-2, and PDA at pH 3 and pH 7.4.

### DETAILED DESCRIPTION

To prepare a present monomer according to FIG. 1, nucleophilic substitution of a dichlorophosphate, for example of ethyl dichlorophosphate, may be performed with two equivalents of an amino acid, the amino acid having an amino acid residue R2 and another residue R3, wherein at least one of said residues R2 and R3 is polymerizable. Amino acid alkynyl ester is suitable, for example.

Preferably, preparation is done at a controlled temperature of 50° C., for example.

FIG. 2 illustrates the degradation of the monomer of FIG. 1 by H₂O. Said degradation takes places in the polymer, too, which is obtained by cross-linking a plurality of the monomers.

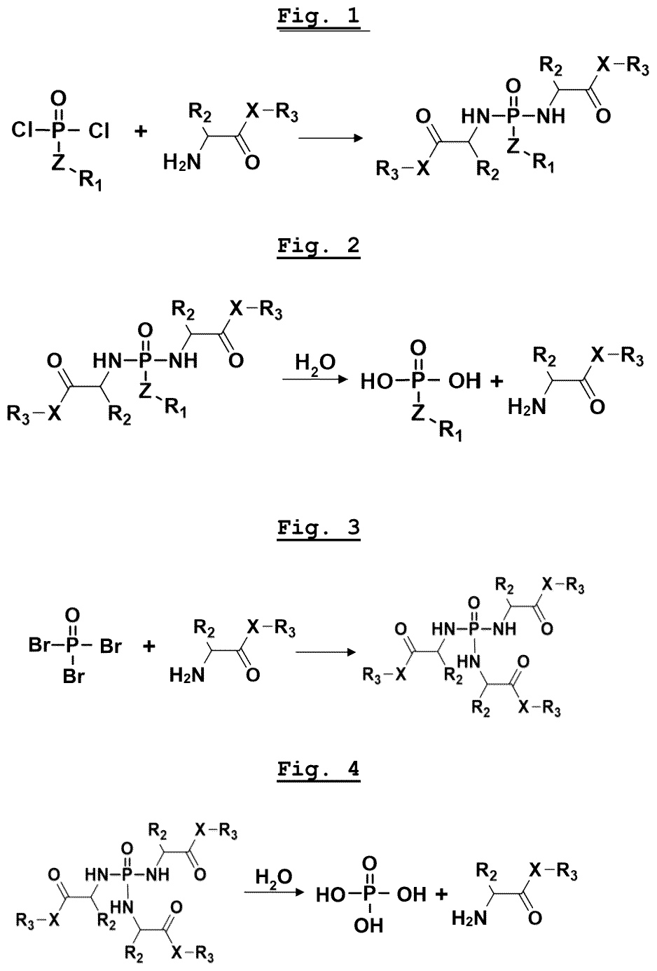

To prepare a present monomer according to FIG. 3, a nucleophilic substitution of phosphor(V)oxybromide may be performed with three equivalents of an amino acid, the amino acid having an amino acid residue R2 and another residue R3, wherein at least one of said residues R2 and R3 is polymerizable.

Preferably, preparation is done at a controlled temperature of 35° C., for example.

FIG. 4 illustrates the degradation of the monomer of FIG. 3 by H₂O. Said degradation takes places in the polymer, too, which is obtained by cross-linking a plurality of the monomers.

The invention was tested based on the synthesis of specific monomers with the present structure. Examples of the synthesis of said monomers are given in examples 1-10.

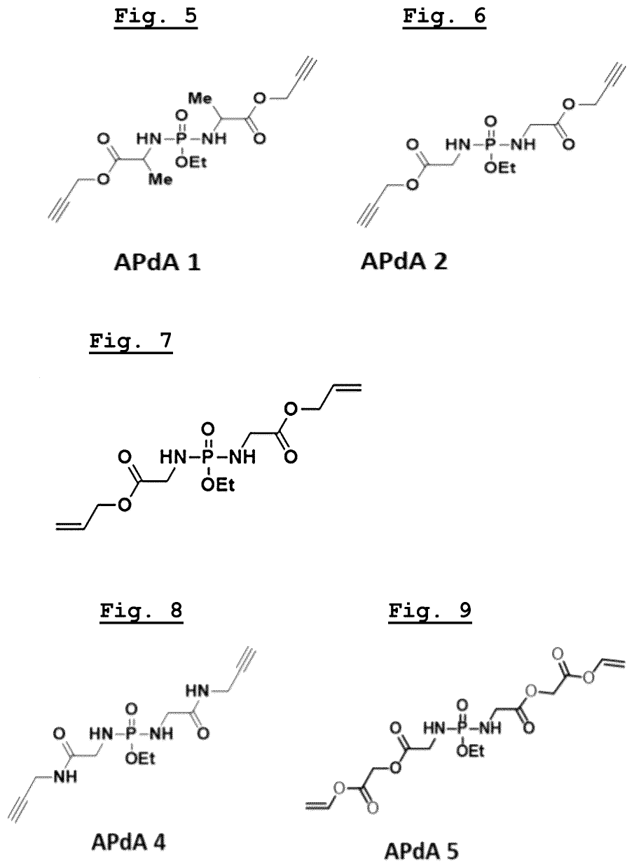

### Example 1 (Designation: APdA-1, FIG. 5)

The following was performed to prepare the substance APdA-1 shown in FIG. 5.

Prop-2-yn-1-yl-L-alaninate hydrochloride (15.0 g, 91.7 mmol, 2.01 eq.) was dispersed in 250 ml acetonitrile and Et₃N (26.8 ml, 193 mmol, 4.2 eq.) was added. The solution was then cooled to 0° C. and ethyl dichlorophosphate (7.45 g, 45.7 mmol, 1.0 eq.) was added slowly under an argon atmosphere. Upon complete addition, the reaction mixture was stirred for 14 hrs at 50° C. Next, the precipitate was removed by filtration and the solvent was removed under reduced pressure. The remaining residuals were again dissolved in EtOAc and washed with brine twice. Finally, the organic phase was dried with MgSO₄ and evaporated under reduced pressure to yield the product as a viscous liquid (13.5 g, 86%).

1H-NMR (300 MHz, CDCl3, δ/ppm): 4.72-4.60 (m, 4H, CH2), 3.97 (quint (J=7.2 Hz), CH3-CH2-O), 3.92 (s, 2H, NH), 3.35 (q (J=9.4 Hz), 2H, CH3-CH), 2.48 (t (J=2.4 Hz), 2H, CH), 1.35 (dd (J1=3.7 Hz, J2=2.8 Hz), 4H, CH3), 1.21 (t (J=7.1 Hz), 3H, CH3-CH2-O).

13C-NMR (75 MHz, CDCl3, δ/ppm): 173.5, 77.2, 75.4. 61.5, 52.6, 49.6, 20.7, 16.2

31P-NMR (121 MHz, CDCl3, δ/ppm): 11.1

ESI-MS: m/z 711.225 [2M+Na]+, 367.106 [M+Na]+, 345.125 [M+H]+

### Example 2 (Designation: APdA-2, FIG. 6)

The following was performed to prepare the substance APdA-2 shown in FIG. 6.

Prop-2-yn-1-ylglycinate hydrochloride (15.0 g, 100 mmol, 2.01 eq.) was dispersed in 250 ml Tetrahydrofuran and Et3N (29.3 ml, 211 mmol, 4.2 eq.) was added. The solution was then cooled to 0° C. and ethyl dichlorophosphate (8.15 g, 50.0 mmol, 1.0 eq.) was added slowly under an argon atmosphere. Upon complete addition, the reaction mixture was stirred for 14 hrs at room temperature. Next, the precipitate was removed by filtration and the solvent was removed under reduced pressure. The remaining residuals were again dissolved in EtOAc and washed with brine twice. Finally, the organic phase was dried with MgSO4 and evaporated under reduced pressure to yield the product as a brown, viscous liquid (14.1 g, 89%).

¹H-NMR (300 MHz, CDCl3, δ/ppm): 4.68 (d (J=2.5 Hz), 4H, CH₂—CH), 4.00 (quint (J=7.2 Hz), 2H, CH₃—CH₂—O), 3.78-3.70 (m, 4H, CH₂), 3.52 (s, 2H NH), 2.48 (t (J=2.5 Hz), 1H, CH), 1.23 (t (J=7.1 Hz), 3H, CH₃).

¹³C-NMR (75 MHz, CDCl3, δ/ppm): 171.8, 77.1, 75.5. 61.7, 52.5, 42.6, 16.2

³¹P-NMR (121 MHz, CDCl3, δ/ppm): 13.5

ESI-MS: m/z 655.158 [2M+Na]⁺, 339.075 [M+Na]⁺, 317.094 [M+H]⁺

### Example 3 (Designation: APdA-3, FIG. 7)

The following was performed to prepare the substance APdA-3 shown in FIG. 7.

Prop-2-ene-1-yl glycinate hydrochloride (15.0 g, 98.7 mmol, 2.01 eq.) was dispersed in 250 ml tetrahydrofurane and Et₃N (28.7 ml, 207 mmol, 4.2 eq.) was added. The solution was then cooled to 0° C. and ethyl dichlorophosphate (8.0 g, 49.1 mmol, 1.0 eq.) was added slowly under an argon atmosphere. Upon complete addition, the reaction mixture was stirred for 14 hrs at room temperature. Next, the precipitate was removed by filtration and the solvent was removed under reduced pressure. The remaining residuals were again dissolved in EtOAc and washed with brine twice. Finally, the organic phase was dried with MgSO₄ and evaporated under reduced pressure to afford the product as a viscous yellow liquid (14.5 g, 92%).

¹H-NMR (300 MHz, CDCl3, δ/ppm): 5.90-5.77 (m, 2H, CH), 5.30-5.17 (m, 4H, CH₂), 4.65 (dt, 4H, CH₂), 4.00 (q, 2H, CH₂), 3.40-3.30 (m, 2H NH), 1.23 (t, 3H, CH₃).

¹³C-NMR (75 MHz, CDCl3, δ/ppm): 171.4, 131.6, 118.7, 65.8, 61.7, 42.7, 16.4

³¹P-NMR (121 MHz, CDCl3, δ/ppm): 13.8

### Example 4 (Designation: APdA-4, FIG. 8)

The following was performed to prepare the substance APdA-4 shown in FIG. 8.

Acetamide, 2-amino-N-2-propyn-1-yl (5.0 g, 44.7 mmol, 2.01 eq.) was dissolved in 100 ml tetrahydrofurane and Et₃N (6.81 ml, 49.1 mmol, 2.2 eq.) was added. The solution was then cooled to 0° C. and ethyl dichlorophosphate (3.62 g, 22.2 mmol, 1.0 eq.) was added slowly under an argon atmosphere. Upon complete addition, the reaction mixture was stirred for 14 hrs at room temperature. Next, the precipitate was removed by filtration and the solvent was removed under reduced pressure. The remaining residuals were again dissolved in EtOAc and washed once with brine. Finally, the organic phase was dried with MgSO4 and evaporated under reduced pressure to afford the product as a yellow-orange viscous liquid (2.75 g, 40%).

¹H-NMR (300 MHz, CDCl3, δ/ppm): 4.18-4.07 (m, 2H, CH₂), 4.07-3.99 (m, 6H, CH₂, NH (overlap)), 3.69-3.58 (m, 4H, CH₂), 2.26 (t, 2H, CH), 1.29 (t, 3H, CH₃).

³¹P-NMR (121 MHz, CDCl3, δ/ppm): 15.2

### Example 5 (Designation: APdA-5, FIG. 9)

The following was performed to prepare the substance APdA-5 shown in FIG. 9.

2-Oxo-2-(vinyloxy)ethylglycinate hydrochloride (10.0 g, 51.2 mmol, 2.01 eq.) was dispersed in 150 ml tetrahydrofurane and cooled to −78° C. Next, Et₃N (14.9 ml, 107 mmol, 4.2 eq.) was slowly added while the temperature was kept at −78° C. Ethyl dichlorophosphate (4.15 g, 25.5 mmol, 1.0 eq.) was then added under an argon atmosphere. Upon complete addition, the reaction mixture was stirred for 10 hrs at −78° C. and then allowed to heat to room temperature overnight. Next, the precipitate was removed by filtration and the solvent was removed under reduced pressure. The remaining residuals were again dissolved in EtOAc and washed twice with brine. Finally, the organic phase was dried with MgSO4 and evaporated under reduced pressure to afford the product as a viscous brownish liquid (8.1 g, 78%).

¹H-NMR (300 MHz, CDCl3, δ/ppm): 7.22-7.13 (m, 2H, CH), 4.90 (dd (J1=13.9 Hz, J2=2.0 Hz), 2H, CH₂) 4.68 (s, 4H, CH₂), 4.61 (dd (J1=6.2 Hz, J2=2.0 Hz), 2H, CH₂), 4.00 (quint (J=7.2 Hz), 2H, 3.88-3-76 (m, 4H, CH₂), 3.29 (s, 2H, NH), 1.23 (t (J=7.1 Hz), 3H, CH₃).

³¹P-NMR (121 MHz, CDCl3, δ/ppm): 13.1

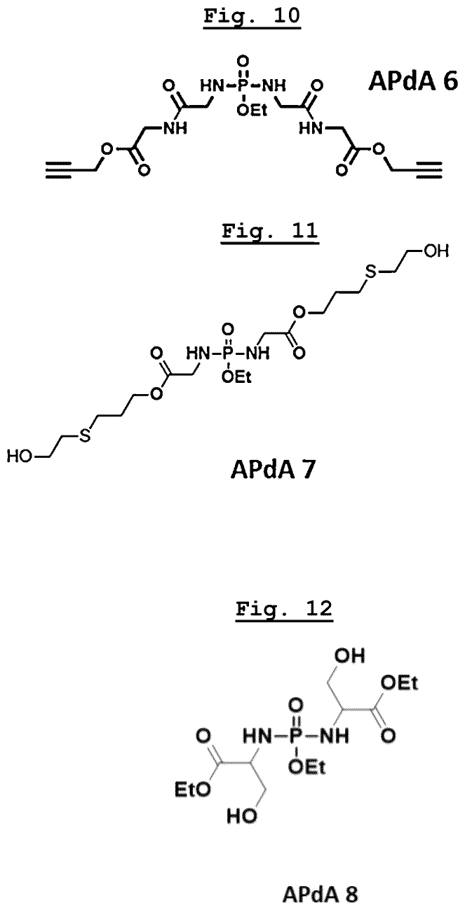

### Example 6 (Designation: APdA-6, FIG. 10)

The following was performed to prepare the substance APdA-6 shown in FIG. 10.

Prop-2-yn-1-ylglycylglycinate hydrochloride (5.15 g, 25 mmol, 2.03 eq.) was dispersed in 80 ml of dry THF and Et₃N (7.6 ml, 55 mmol, 4.46 eq.) was added. The mixture was cooled and ethyl dichlorophosphate (2 g, 12.3 mmol, 1 eq.) was added dropwise. Conversion was then performed for 16 hrs at RT. The precipitate was then filtered off and the solvent removed in vacuo. The residuals were then again dissolved in DCM and washed with 10% by weight NH₄Cl and saturated NaHCO₃ solution. Finally, the organic phase was dried with MgSO4 and evaporated under reduced pressure to afford a viscous yellowish liquid (4.0 g, 76%).

¹H-NMR (300 MHz, CDCl3, δ/ppm): 7.94 (t (J=5.8 Hz), 2H, NH), 4.73 (d (J=2.5 Hz), 4H, CH₂), 4.41 (q (J=5.0 Hz), 2H CH₃CH₂), 4.10-3.90 (m, 4H, CH₂) 4.10-3.90 (m, 2H, NH), 3.70-3.54 (m, 4H, CH₂), 2.49 (t (J=2.5 Hz), 2H, CH), 1.23 (t (J=7.1 Hz), 3H, CH₃).

³¹P-NMR (121 MHz, CDCl3, δ/ppm): 15.3

### Example 7 (Designation: APdA-7, FIG. 11)

To prepare APdA-7, the APdA-3 described with regard to FIG. 7 (2.0 g, 6.2 mmol, 1 eq.) was dissolved in 25 ml of dry chloroform and the photoinitiator TPO-L (30 mg, 1.5% by weight) was added. The solution was then flushed with argon, whereupon mercaptoethanol (0.91 ml, 13 mmol, 2.07 eq.) was added. The solution was now converted for 12 hrs at 4-5° C. in a photochemical reactor at 365 nm. Next, the solvent was evaporated, and the residuals were extracted with ether four times to remove traces of mercaptoethanol. Finally, the product was dried on a rotary evaporator to afford a thick, viscous liquid (2.7 g, 91%).

¹H-NMR (300 MHz, CDCl3, δ/ppm): 4.33-4.21 (m, 4H, CH₂), 4.07 (quint (J=7.3 Hz), 3H, CH₃CH₂), 3.74 (t (J=6.1 Hz), 4H, CH₂) 3.74 (s (overlapped by t 3.74) 4H, CH₂), 3.42 (s, 2H, NH), 3.26 (s, 2H, OH), 2.72 (t (J=6.1 Hz), 4H, CH₂), 2.64 (t (J=7.2 Hz), 4H CH₂), 1.96 (quint (J=6.7 Hz), 4H, CH₂), 1.31 (t (J=7.0 Hz), 3H, CH₂CH₃).

³¹P-NMR (121 MHz, CDCl3, δ/ppm): 13.9

### Example 8 (Designation: APdA-8, FIG. 12)

The following was performed to prepare the substance APdA-8 shown in FIG. 12.

Serin ethylester HCl (1 eq.) was neutralized with Et₃N (1 eq.) and filtered under reduced pressure using THF. For the next step, 40 ml THF were cooled down to −78° C. Ethyl dichlorophosphate (0.41 g. 2.5 mmol 1 eq.) and Et₃N (0.71 ml. 5.1 mmol, 2 eq.) were added under an argon atmosphere. Then, the serine ethylester (0.83 g, 6.25 mmol, 2.5 eq.) was added. The reaction mixture was stirred for 14 hrs while being slowly heated to room temperature. The precipitate was filtered and the solvent removed under reduced pressure. The product was washed with EtOAc using column chromatography to afford a slightly yellowish viscous liquid (yield: 0.69 g 78%).

¹H-NMR (300 MHz, CDCl3, δ/ppm): 1.25 (bm, 9H), 3.9 (m 2H), 4.04 (m, 2H), 4.2 (m, 6H)

³¹P-NMR: (121 MHz, CDCl3, δ/ppm): 6.0

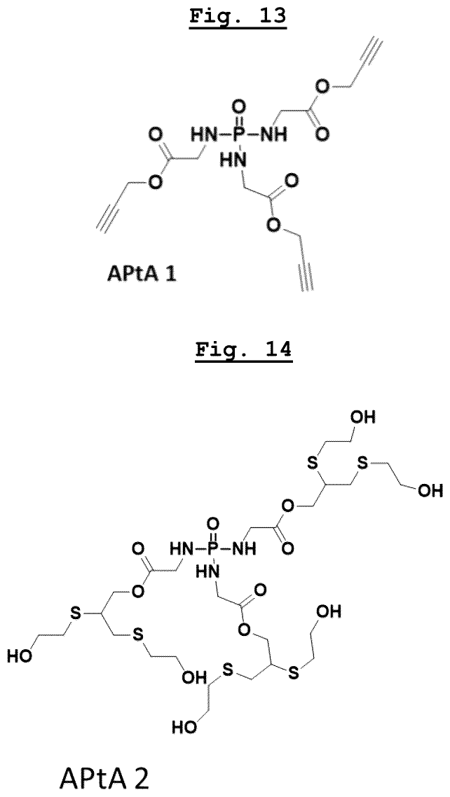

### Example 9 (Designation: APtA-1, FIG. 13)

The following was performed to prepare the substance APtA-1 shown in FIG. 13.

Prop-2-in-1-ylglycinat (11.0 g, 73.7 mmol, 3.02 eq.) was dispersed in 200 ml acetonitrile and Et₃N (21.5 ml, 155 mmol, 6.3 eq.) was added. The mixture was then cooled to 0° C. and a solution of phosphor(V)oxybromide (7.0 g, 24.4 mmol, 1.0 eq.) in 15 ml acetonitrile was added slowly under an argon atmosphere. Upon complete addition, the reaction mixture was stirred for 14 hrs at 35° C. Next, the precipitate was removed by filtration and the solvent was removed under reduced pressure. The remaining residuals were again dissolved in EtOAc and washed twice with brine. Finally, the organic phase was dried with MgSO4 and evaporated under reduced pressure to afford the product as dark brown, highly viscous liquid (8.6 g, 92%).

¹H-NMR (300 MHz, CDCl3, δ/ppm): 4.73 (d (J=2.4 Hz), 6H, CH₂), 3.90-3.77 (m, 6H, CH₂), 2.51 (t (J=2.4 Hz), 3H, CH)

³¹P-NMR (121 MHz, CDCl3, δ/ppm): 15.3

¹³C-NMR (75 MHz, CDCl3, δ/ppm): 171.8, 76.7, 75.6, 52.7, 42.6

### Polymerization Example Including Example 9

The following representative method for preparing a hydrogel is described based on APtA-1: APtA-1 (278 mg, 0.73 mmol, 1 eq.) was weighed out with a hydrophilic, water-soluble PEG-PPG-dithiol comonomer (MW 918 g mol-1) (2.0 g, 2.17 mmol, 3 eq.) and Li-TPO-L (34.7 mg, 1.5% by weight). The blend was dissolved in 1.5 ml deionized water and then cured at 365 nm overnight to afford an insoluble hydrogel.

Preparation is thus done according to the following scheme:

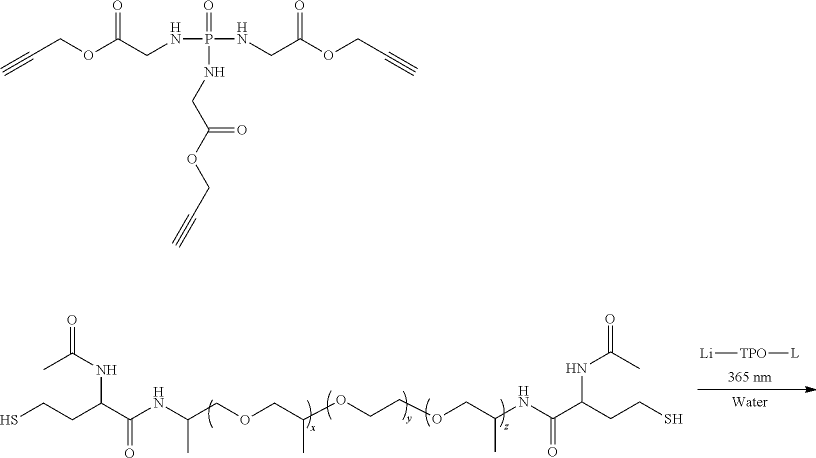

### Example 10 (Designation: APtA-2, FIG. 14)

The following was performed to prepare the substance APtA-2 shown in FIG. 14.

The APtA 1 described with regard to FIG. 13 (2.5 g, 6.5 mmol, 1 eq.) was dissolved in 30 ml of a Chloroform/Ethanol (1:1) blend and the photoinitiator TPO-L (38 mg, 1.5% by weight) was added. The solution was then flushed with argon, whereupon mercaptoethanol (2.8 ml, 40 mmol, 6.1 eq.) was added. The solution was now converted for 12 hrs at 4-5° C. in a photochemical reactor at 365 nm. Next, the solvent was evaporated, and the residuals were extracted with ether four times to remove traces of mercaptoethanol. Finally, the product was dried on a rotary evaporator to afford a thick, viscous liquid (5.0 g, 90%).

¹H-NMR (300 MHz, D₂O, δ/ppm): 4.47-4.25 (m, 6H, CH₂), 3.83-3.62 (m, 18H, CH₂), 3.21 (quint (J=5.9 Hz), 3H, CH), 2.92-2.65 (m, 18H, CH₂).

³¹P-NMR (121 MHz, DMSO_{d6}, δ/ppm): 15.6

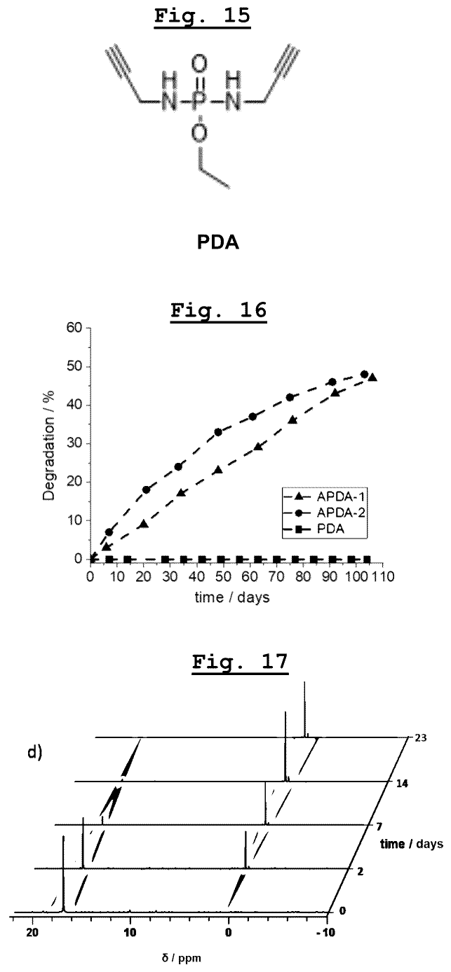

### Comparative Example PDA (Designation: PDA, Non-Inventive Monomer, FIG. 15)

As a comparative monomer, a phosphorodiamidate (PDA) equivalent to APdA-1 and APdA-2, which has no amino acid but two propargylamines bound directly to the phosphorus atom, was used.

Propargylamine (8.45 ml, 132 mmol, 2.15 eq.) was dissolved in 100 ml of dry THF and Et₃N (20.1 ml, 145 mmol, 2.4 eq.) was added. The solution was then cooled to 0° C. and ethyl dichlorophosphate (10.0 g, 61.4 mmol, 1.0 eq.) was added slowly under an argon atmosphere. Upon complete addition, the reaction mixture was stirred for 14 hrs at room temperature. The precipitate was removed by filtration and the solvent removed under reduced pressure. The remaining residuals were again dissolved in EtOAc and washed twice with brine. Finally, the organic phase was dried with MgSO₄ and evaporated under reduced pressure to afford the product as a soft brown solid (11.2 g, 56.0 mmol, 92%).

¹H-NMR (300 MHz, CDCl3, δ/ppm): 4.07 (quint (J=5.8 Hz), 2H, CH₃—CH₂—O), 3.76-3.69 (m, 2H, CH₂), 3.03 (s, 2H, NH), 2.24 (t (J=2.5 Hz), 2H, CH), 1.31 (t (J=7.1 Hz), 3H, CH₃).

¹³C-NMR (75 MHz, CDCl3, δ/ppm): 81.8, 71.1, 61.5, 30.5, 16.2

³¹P-NMR (121 MHz, CDCl3, δ/ppm): 13.7

ESI-MS: m/z 423.136 [2M+Na]⁺, 223.062 [M+Na]⁺, 201.079 [M+H]+

### Experiments Regarding the Invention Based on Exemplary Monomers APdA-1, APdA-2, and Comparative Monomer PDA

For the experimental description of the invention, amino-acid-based phosphorodiamidate (APdA) monomers with alkynyl units were designed for subsequent thiol-yne-photopolymerization. The good leaving-group character of the amino acid was supposed to increase the tendency for hydrolysis, the α substituent providing an approach for synchronizing the hydrolysis rates by sterical hindrance of H₂O. The alkyne-functionalized monomers (APdA-1 and APdA-2) were prepared by simple nucleophilic substitution of ethyl dichlorophosphate with two equivalents of the respective amino acid alkynyl ester (see the description of FIGS. 5 and 6). For comparison, the alkynyl phosphorodiamidate monomer PdA was also prepared without amino acid spacers by direct substitution of POC120Et with propargylamine (see description of FIG. 15). As stated in the above examples, the chemical structures and purities of the monomers were confirmed by 1H-, 13C-, 31P-NMR spectroscopy and mass spectrometry.

### Degradation of Monomers

Degradation of APdA-1, APdA-2, and PDA was monitored at pH values of 7.4 at 37° C. 30 mg of each monomer was dissolved in 0.9 ml of buffer solution (pH 7.4:1 M HEPES, pH 3.0:1 M citric acid) and 0.1 ml D₂O and transferred into NMR tubes. The samples were then incubated at 37° C. and 31P-NMR was recorded in regular intervals. The degree of degradation was then calculated based on the signal ratio between monomer signal and degradation signal.

In FIG. 16, the degradation of the three monomers at a pH of 7.4 is shown based on the change in phosphate ratio in 31P NMR spectroscopy. The essential findings are that no degradation occurs in PDA and that the degradation of APdA-2 is faster than that of APdA-1.

This demonstrates that the inventive monomers are degradable because, unlike PDA, they have amino acids. It also demonstrates that the degradation behavior can be influenced via the residue R2, since APdA-1 and APdA-2 are identical but for this residue R2.

In APdA-1, R1=Me and in APdA-2, R1=H. The methyl group of the APdA-1 thus shows a shielding effect which delays the dissolution of the NH bond of the amino acid to the phosphorus atom.

For comparison, the above degradation experiment was also performed at pH 3.0, wherein quick degradation of PDA and APdA-2 and slower degradation of APdA-1 was observed.

As briefly described above, the hydrolytic stability of the monomers in D₂O (1 M HEPES-Puffer, 37° C.) was measured at pH 7.4 (FIG. 16). The 31P-NMR resonance signal remained unchanged for the PdA monomer not containing an amino acid over the monitored period of 229 days, which indicates considerable hydrolysis resistance on the part of this compound. Meanwhile, the amino-acid-containing monomers exhibited clear hydrolysis by cleaving the P—NH bonds to afford the phosphate peaks at 1.5 ppm. This can be seen from FIG. 17, which shows the degradation of APdA-2 at pH 3.0. The phosphorus signal of the monomer at 17 ppm decreases over time, while the new signal of the phosphate appears at 1.5 ppm. After 23 days, the monomer was fully degraded into the respective phosphate products.

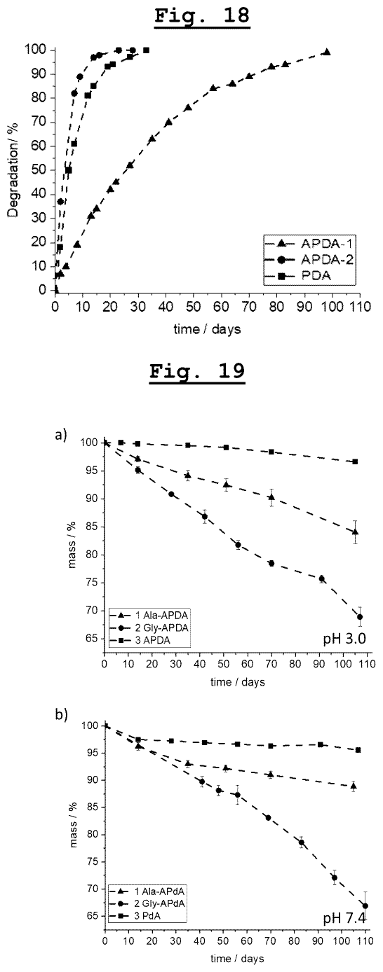

The phosphate and amino acid degradation products were also confirmed by MS spectrometry. Moreover, it was observed that the hydrolysis rate for APdA-2 is faster than that for APdA-1 (FIG. 16), which is attributed to the shielding effect of the methyl-α substituent. In addition, hydrolysis at pH 3.0 (1 M citric acid/D₂O) was also examined. At this pH, considerable acceleration of the hydrolysis was observed for all monomers (FIG. 18). A range of biomedical applications require polymer materials that are degraded at low pH values, which makes this observed degradation an interesting property.

### Representative Method for the Thiol-Ene/Yne Mass Polymerization of Monomers

The monomers APdA-1, APdA-2, and PDA were subjected to photopolymerization at a stoichiometric ratio with the trithiol (1,1,1-tris-(hydroxymethyl)-propane tris-(3-mercaptopropionate) (TMPMP) typically used.

The product obtained according to example 1 designated APdA-1 (648 mg, 1.9 mmol), trimethylolpropane tris-(3-mercaptopropionate) (1.0 g, 2.5 mmol), and TPO-L (25.0 mg, 1.5% by weight) were mixed homogeneously. Then, the blend was cured under UV light at 365 nm for 1 hr, affording a cross-linked resin.

The comparative monomer PDA (377 mg, 1.9 mmol), trimethylolpropane tris-(3-mercaptopropionate) (TMPMP) (1.0 g, 2.5 mmol), and TPO-L (21 mg, 1.5% by weight) were mixed homogeneously. Then, the blend was cured in an UV reactor at 365 nm for 1.5-2 hrs, affording a cross-linked resin.

The monomer conversion was analyzed by RT-FTIR spectroscopy, in which the reaction was followed by a decrease of the alkyne band at 2130 cm-1. Additionally, the depletion of thiol units (2570 cm-1) and the formation of vinyl sulphide groups (2095 cm-1) may be detected as intermediate products. APdA-1 (Gly-APdA) and APdA-1 (Ala-APdA) exhibit a slightly higher final MC than PdA. The photokinetics may be measured by photoDSC with 5% by weight TPO-L as an initiator. The three monomers all showed adequate curing kinetics with tmax between 8.6 and 9.7 s. The mechanic mass properties of the resulting polymers were analyzed and are shown in table 1 below. The values are comparable to similar thiol-yne-based polymers with TMPMP, but it is assumed that they can be improved significantly by using alternative thiol copolymers.

TABLE 1
The photochemical properties and volume
properties of the thiol-yne polymers

| monomer | tₘₐₓ/s | MC/% | η/mPa s | Tg/° C. |
|---|---|---|---|---|
| PdA | 8.97 ± 0.09 | 89.6 ± 2.0 | 62 | 27 |
| Gly- | 9.74 ± 0.19 | 94.9 ± 0.38 | 321 | 30 |
| APdA | | | | |
| Ala- | 8.56 ± 0.17 | 92.5 ± 0.71 | 257 | 33 |
| APdA | | | | |

To demonstrate the applicability of the monomers for photopolymerization, samples were prepared for multi-photolithography (MPL). A 30×30×1.6 μm³ grid was prepared with a lithography setup. The grid side walls consist of 4 partially overlapping excitation voxels (each ~0.5 μm high) that are written on top of each other for improved stability. MPL was conducted at an excitation performance of 31 GW/cm2 and a writing speed of 7 μm/s (excitation wavelength: 515 nm fs-pulsed), each voxel being illuminated twice.

This experiment served to confirm that the inventive monomers are printable into polymerized three-dimensional structures using 3D printing.

### Loss of Mass in Polymerized Monomers

Degradation of the solid (polymer) obtained by polymerizing the monomers was analyzed in studies on loss of mass. Cured sample slices were first soaked in EtOAc to extract all non-converted monomers and then dried to record the m₀ value. The sample slices were then preserved in buffer solutions and incubated at 37° C. (sample unstirred). In regular time intervals, the samples were removed, dried and their weight recorded (in triplicate). The data was used to calculate the decrease in mass.

FIG. 19 shows plots of a loss of mass test (triplicates) on solids at 37° C. in % of baseline mass m₀ at pH 7.4 (a) and pH 3.0 (b). While the polymer based on PDA is stable at pH 7.4 and pH 3.0, the polymers based on APdA-1 and APdA-2 showed slow, nearly linear loss of mass.

For the samples containing APdA-1 (Ala-APdA) and APdA-2 (Gly-APdA), a nearly linear decrease in mass and therefore degradation of the sample was observed. The degradation of the solid material shows the same trend as the previously described monomer degradation in solution in order with alkyne phosphorodiamidate PDA<APdA-1<APdA-2. In fact, the solid material derived from the monomer PDA that did not contain any amino acids exhibits only minimal degradation over the measured time frame and under the measured conditions. This observation suggests that the potentially hydrolysable ester bonds of the TMPMP as well as the NH bond of PDA are highly stable under these mild conditions in this polymer system. Interestingly, while degradation of the pure monomers at pH 3.0 is highly accelerated, the pH has little effect on the degradation process of the polymers. This observation indicates a very low diffusion rate of the solvent into the materials. The nearly linear nature of the degradation process, combined with the near pH independence of the degradation rates, suggests a surface erosion mechanism for such polymer systems. Surface erosion, generally expressed by a linear loss of mass over time, is a highly desirable, but rarely achieved property for biodegradable materials that are designed to be used as biological materials.

A such behavior causes a more uniform and thus predictable loss of mechanical properties and a more uniform and thus more predictable release of biologically active substances when polymers are used for delivery purposes.

To summarize, a novel type of hydrolytically cleavable phosphoroamidate monomers with amino acid links has been invented. It has been determined that the amino acids are quickly cleaved off the phosphate at pH 7.4, a process that is even accelerated at an acidic pH. Photopolymerization may be performed in combination with known trifunctional thiols, and it has been demonstrated that they are 3D-MPL-writable. It has been observed that the cured polymers have linear, pH-independent loss-of-mass profiles, which indicates a surface erosion mechanism, the rate of which can be adjusted by the choice of amino acid. This property in combination with the materials' good cytocompatibility and the endogenous nature of the main degradation products makes these materials highly interesting, e.g. for the future development as degradable biological structures.

1-9. (canceled)

10. A polymerizable monomer, comprising:
exactly one phosphorus atom;
wherein an oxygen atom having a double bond is present on the phosphorus atom;
wherein two or three identical amino acids are each bound to the phosphorus atom via one NH group;
wherein, in the case of two identical amino acids, one R1 residue is bound to the remaining binding site of the phosphorus atom;
wherein each amino acid has an amino acid residue adjacent to the NH group; and
wherein the hydroxy group of the carboxy group of the amino acid is replaced by X—R3, wherein R3 is another residue;
wherein X is selected from O, NH, S, and CH2;
wherein the R3 residue comprises a polymerizable group; and
wherein several of the polymerizable monomers are directly polymerizable with one another via these polymerizable groups or are polymerizable with a second type of monomers via these polymerizable groups to form copolymers.

11. The polymerizable monomer of claim 10, wherein the polymerizable monomer has the structural formula

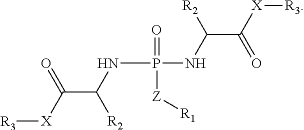

12. The polymerizable monomer of claim 11, wherein:
X represents O, NH, or S; and
Z represents O, NH, or S.

13. The polymerizable monomer of claim 10, wherein the polymerizable monomer has the structural formula

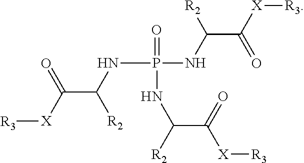

14. The polymerizable monomer of claim 13, wherein X represents O, NH, or CH₂.

15. The polymerizable monomer of claim 10, wherein R2 is the side chain of alanine, arginine, asparagine, aspartic acid, cysteine, glutamine, glutamic acid, glycine, histidine, isoleucine, leucine, lysine, methionine, phenylalanine, proline, serine, threonine, tryptophane, tyrosine, or valine.

16. The polymerizable monomer of claim 10, wherein R2 is selected depending on the desired degradation rate of the monomer and thus the desired degradation rate a polymer based on the monomers, wherein if R2 is a large group, water molecules are more likely prevented from reaching the NH bond than of R2 is a small group and if R2 is a hydrophobic group, water molecules are more likely prevented from reaching the NH bond than of R2 is a hydrophilic group.

17. The polymerizable monomer of claim 10, wherein only R3 comprises a polymerizable group.

18. The polymerizable monomer of claim 10, wherein R1 is not a nucleoside.

19. A method of preparing a polymer using polymerizable monomers of claim 10, wherein the polymerizable monomers are cross-linked directly via their polymerizable groups.

20. A method of preparing a polymer using polymerizable monomers of claim 10, wherein said polymerizable monomers are polymerized into copolymers in the presence of at least one second type of monomers.

21. A use of the polymerizable monomers of claim 10, wherein, in a non-polymerized state, the polymerizable monomers are present as a liquid in a device for 3D printing, and are cured into a 3D structure or a 3D object.

22. A use of the polymerizable monomers of claim 21, wherein, the device for 3D printing is one of a device for photopolymerization 3D printing and a device for multi-photon lithography.

23. A polymer produced using a polymerizable monomer according to claim 10, wherein the polymerizable monomers are crosslinked directly to one another via their polymerizable groups or by means of at least one comonomer.

24. A polymer according to claim 23, wherein the polymer is present as a 3D structure or as a 3D object.

25. A polymer according to claim 23, wherein the polymer is degradable by the breaking of the NH bonds at the phosphorus atom of the polymerizable monomer by water molecules.
